(19) United States
(12) Patent Application Publication
(10) Pub. No.: US 2008/0171201 A1
(43) Pub. Date: Jul. 17, 2008

(54) Graphite-Mediated Control of Static Electricity on Fiberglass

(76) Inventors: Ronald A. Houpt, Shelbyville, IN (US); Lawrence R. Thomas, Indianapolis, IN (US); Francis Cloudt, Camas, WA (US); Brandon J. Dalrymple, Noblesville, IN (US); Matthew W. Revercomb, Indianapolis, IN (US)

Correspondence Address: BARNES & THORNBURG LLP, 11 SOUTH MERIDIAN, INDIANAPOLIS, IN, 46204, US

(21) Appl. No.: 12/013,181

(22) Filed: Jan. 11, 2008

Related U.S. Application Data
(60) Provisional application No. 60/884,716, filed on Jan. 12, 2007.

(51) Int. Cl. B32B 17/02; B05D 3/02

(52) U.S. Cl. 428/368; 427/372.2

(57) ABSTRACT

A fiberglass material contains glass fibers having graphite evenly distributed thereon. The graphite provides a coating that makes the fiberglass material substantially free of static electricity. Suitable graphite content of the fiberglass material is about 0.25 wt % to about 0.50 wt %, or about 0.25 wt % to about 1.0 wt %, or about 0.8 wt % of dry weight of the glass fibers. The graphite used may be synthetic material or natural material substantially free of silica. Other components of the fiberglass material may include de-dusting oil.

### CROSS REFERENCE TO RELATED APPLICATION

This application claims the benefit of U.S. Provisional Application No. 60/884,716, filed Jan. 12, 2007.

### TECHNICAL FIELD

The present invention relates to a fiberglass material and a method for producing the same, particularly a fiberglass material that is substantially free of static electricity.

### BACKGROUND

Fiberglass is used in a variety of thermal insulation applications including, for example, in building insulation, pipe insulation, and in molded automobile parts (e.g., hood liners), as well as in a variety of acoustical insulation applications including, for example, in molded automobile parts (e.g., dashboard liners) and office furniture/panel parts. A general discussion of fiberglass manufacturing and technology is contained in Fiberglass by J. Gilbert Mohr and William P. Rowe, Van Nostrand Reinhold Company, New York 1978, the disclosure of which is hereby incorporated herein by reference.

Certain fiberglass insulation products include matted glass fibers that are bound or held together by a cured, water-resistant thermoset binder. During production of such products, streams of molten glass are drawn into fibers of varying lengths and then blown into a forming chamber where they are deposited with little organization, or in varying patterns, as a mat onto a traveling conveyor. The fibers, while in transit in the forming chamber and while still hot from the drawing operation, are sprayed with an aqueous binder solution. In addition to binders, an anti-static composition, typically consisting of a material that minimizes the generation of static electricity and a material that serves as a corrosion inhibitor and a stabilizer, may also be sprayed onto the surface of glass fiber mats. The residual heat from the glass fibers and the flow of cooling air through the fibrous mat during the forming operation generally evaporates most of the water from the binder and any anti-static composition, and causes the binder and anti-static agent to penetrate the entire thickness of the mat. Subsequently, the coated fibrous mat is transferred out of the forming chamber to a transfer zone where the mat vertically expands due to the resiliency of the glass fibers. The coated mat is then transferred to a curing oven, where heated air is blown through the mat, or to a curing mold, where heat may be applied under pressure, to cure the binder and rigidly attach the glass fibers together for use in various types of cured fiberglass insulation products (e.g., building insulation, molded automobile hood liners, and office furniture/panel parts).

Other types of fiberglass insulation products include glass fibers that are not bound or held together by a cured binder. During production of such products, streams of molten glass are drawn into fibers of varying lengths and then blown into a forming chamber where they are deposited with little organization, or in varying patterns, as a mat onto a traveling conveyor. Subsequently, the fibrous mat is transferred out of the forming chamber to a transfer zone where the mat vertically expands due to the resiliency of the glass fibers. The expanded glass fiber mat is then sent through a mill, e.g., a hammermill, to be cut apart, after which treatment various types of fluids, including oil, silicone, and/or anti-static compounds, may be applied. The resulting glass fibers, commonly known as “loose-fill” fiberglass, are collected and compressed into a bag for use in various types of uncured fiberglass insulation products (e.g., attic insulation).

Despite the use of one or more anti-static agents, static electricity, in the form of a static charge, may build up on the surface of individual glass fibers in fiberglass insulation products, such as the afore-mentioned cured fiberglass insulation products and loose-fill fiberglass.

Static electricity, which is a function of mechanical motion, atmospheric conditions, and/or location in an electric field, may cause end product loss and/or downtime in manufacturing and commercial applications involving fiberglass, and can be hazardous in explosive environments. For example, static electrical charge accumulated during manufacturing of cured fiberglass insulation may lead to an unwanted accumulation of dust on an insulation product, by virtue of dust being attracted to a statically-charged surface. Such accumulated dust may have to be removed in order for the insulation product to be within a desired dust specification. Further, during the commercial installation of uncured loose-fill fiberglass insulation, glass fibers blown through several hundred feet of plastic (e.g., polyethylene) tubing several inches in diameter experience high-speed mechanical motion, and may acquire a static electrical charge as a result. Such statically-charged fiberglass may accumulate in undesirable locations, including, for example, on the underside of a roof, on rafters, and/or on ductwork, and even on the installer him- or herself, often resulting in an unpleasant, but usually not life-threatening (unless flammable solvents are present), electrical shock.

Accordingly, compositions and methods for controlling static electricity build up on glass fibers during the manufacture and installation of fiberglass insulation has continued to receive attention.

### SUMMARY

The present invention may comprise one or more of the following features and/or combinations thereof. A fiberglass material contains glass fibers having graphite evenly distributed thereon. The graphite acts as an anti-static coating, therefore, the fiberglass material described herein is substantially free of static electricity. The fiberglass material may have any suitable graphite content, for example, about 0.25 wt % to about 0.50 wt % of dry weight of the glass fibers, or about 0.25 wt % to about 1.0 wt %, or about 0.8 wt %. The graphite used to produce the fiberglass material may be synthetic or natural graphite, having carbon content of about 90% to about 100%. The fiberglass material may also include small amounts of other components, for example, silicone, de-dusting oil, dye, or any combination thereof. The fiberglass material is particularly suitable for use in thermal insulation applications.

In a specific example, the fiberglass material is used as a loose-fill fiberglass insulation. The fiberglass insulation includes loose-fill fiberglass and dry graphite powder distributed throughout the fiberglass. The graphite content of about 0.25 wt % to about 0.50 wt %, or about 0.25 wt % to about 1.0 wt %, or about 0.8 wt % of the dry weight of the loose-fill fiberglass is sufficient for the fiberglass insulation to be substantially free of static electricity during production and installation. The insulation material may also contain de-dusting oil at about 0.1 wt % to about 2.0 wt % or less.

In another aspect, a method for producing a fiberglass material substantially free of static electricity is described. The method generally involves mixing dry graphite with glass fibers so that the graphite is evenly distributed on the glass fibers. As above-mentioned, the graphite used may be natural graphite or synthetic graphite in the form of powder or flakes. The powdered graphite may have a particle size of about 1 micron to about 50 microns. The carbon content of the graphite may be about 90 wt % to about 100 wt %. The graphite may be used at any suitable rate. For example, the graphite of about 0.25 wt % to about 0.50 wt %, or about 0.25 wt % to about 1.0 wt %, or about 0.8 wt % of dry weight of the glass fibers may be used. A de-dusting oil may also be added to the glass fibers.

Alternatively, graphite in a fluid form may be used to apply to the glass fibers to make a fiberglass material substantially free of static electricity. The method may start with mixing graphite with a fluid such as water or oil to form a dispersion. The dispersion may contain any suitable amount of the graphite. For example, a dispersion containing about 3.4 wt % graphite is a suitable graphite mixture. The rate of application may vary and depend on the desired coverage of the graphite. However, as above-mentioned, the resulting fiberglass material should contain about 0.25 wt % to about 0.50 wt %, or about 0.25 wt % to about 1.0 wt %, or about 0.8 wt % of dry weight of the glass fibers. The dispersion may further contain a dispersant or a wetting agent to facilitate wetting of the graphite or a thickener to increase the viscosity of the dispersion, or both. After the dispersion is applied over the glass fibers, the glass fibers are dried and the graphite residue is left attached to the glass fibers.

The method of making the present fiberglass material can be integrated with the manufacturing process of a loose-fill fiberglass insulation material. The new manufacturing process generally includes fiberizing starting glass material into glass fibers, chopping or milling the glass fibers into short pieces as chopped glass fibers, and packaging the chopped glass fibers in a bag. The process also includes applying graphite to either the glass fibers before the chopping step or to the chopped glass fibers after the chopping step. It is possible to add graphite to the chopped glass fibers at various locations along the transport line up to the packaging step. In the manufacturing process, it is possible to apply either dry graphite or graphite suspension to the glass fibers. Both synthetic and natural graphite may be used. Graphite powder may be mixed with a fluid such as water or light oil to make a dispersion for injecting over the glass fibers. Using a fluid dispersion requires the glass fibers to be dried. In one application, the graphite dispersion is applied to the glass fiber veil at the fiberizer, the heat from the fiberizer will dry the glass fibers leaving the graphite attached to the glass fibers. In another application, dry graphite powder is added over the chopped glass fibers after they pass through a hammermill and being transported in a negative pressured air duct. In another application, the graphite dispersion is injected over the chopped glass fibers in an injection area before they reach an air/fiber separator. In an alternative application, the dry graphite powder is added to the chopped glass fibers right before they are compressed into a continuous sheet in an air/fiber separator. In yet another application, dry graphite powder is added on to the continuous sheet of glass fibers on a conveyor belt prior to entering a bagging operation. The graphite content in the manufactured product should be about 0.25 wt % to about 0.50 wt %, or about 0.25 wt % to about 1.0 wt %, or about 0.8 wt % of the glass fibers, using graphite having particle sizes of about 1 micron to 50 microns. It is contemplated the graphite content may vary due to the sizes of the graphite particles used.

It is to be understood that other substances such as including a de-dusting oil, silicone, a dye or a binder may also be applied to the glass fibers together with the graphite powder or the graphite dispersion. The graphite dispersion may also include a dispersant, a thickener, or any combination thereof.

Additional features of the present invention will become apparent to those skilled in the art upon consideration of the following detailed description of illustrative embodiments exemplifying the best mode of carrying out the invention as presently perceived.

### BRIEF DESCRIPTION OF THE DRAWINGS

FIG. 1 is a diagram representing an embodiment of a manufacturing process for making a fiberglass material.

### DETAILED DESCRIPTION

Despite the use of traditional anti-static agents, static electricity is usually built up on the surface of individual glass fibers in fiberglass insulation products during manufacturing and installation. The fiberglass material described herein is substantially free of static electricity. The fiberglass material contains glass fibers having graphite attached or coated on the surface thereof.

Depending on the form of the glass fibers, a variety of fiberglass products may be made from the present fiberglass material. The glass fibers may be continuous fibers used in yarns and textile or discontinuous fibers which are short pieces of fibers used as batts, blankets or boards for insulation or infiltration. The continuous fiberglass yarn may be woven into fabric which may be used as draperies or as a reinforcement material for mold and laminated plastics. The discontinuous glass fibers may be formed into wool like material that is thick and fluffy suitable for use for thermal insulation and sound absorption. The discontinuous glass fibers is used to form a loose-fill fiberglass material that is commonly used for home insulation.

The glass fibers may be made of any suitable raw materials. For example, the glass fibers may be produced from a variety of natural minerals or manufactured chemicals such as silica sand, limestone, and soda ash. Other ingredients may include calcined alumina, borax, feldspar, nepheline syenite, magnesite, and kaolin clay. The method of forming fibers (fiberization) from the raw glass material is generally known in the art. The fibers once formed, may be pulverized, cut, chopped or broken into suitable lengths for various applications. Several devices and methods are available to produce short pieces of fibers and are known in the art.

The graphite used to make the present fiberglass material may be natural graphite or synthetic graphite. The naturally occurring graphite is typically found as discrete flakes ranging in size from 50 to 800 microns in diameter and 1-50 microns thick. This form of graphite usually exhibits high thermal and electric conductivity. Commercial grades are available in purities ranging from 80-99.9% carbon, and sizes from 2 to 800 micrometers. The synthetic graphite is made by high temperature heat treatment of amorphous carbon materials. The morphology of most synthetic graphite varies from flaky in fine powders to irregular grains and needles in coarser products. Synthetic graphite is available in particle sizes from 2-micron powder to 2 cm pieces. The synthetic graphite has relatively high purity because the high processing temperature vaporizes the impurities including metal oxides, sulfur, and other organic components of the raw materials. Purities are typically 99+% carbon. It is desirable, for health and safety reasons, that the graphite used in the present application is substantially pure and contains no silica. Because the synthetic graphite is substantially pure and can be made into uniformly fine powder, the synthetic graphite is well suited for making the present fiberglass material.

The present fiberglass material may contain a suitable amount of graphite that allows an even distribution on the surface of the glass fibers. The size of the graphite particles will have an effect on the distribution of the graphite. If the particles are relatively large, the coverage on the glass fibers may not be as even as if the smaller particles are used. Therefore, it may be necessary to increase the amount (weight) of the graphite applied to the glass fibers, when the large graphite particles are used. It has been discovered that the present fiberglass material should have a graphite content of about 0.25 wt % to about 0.50 wt %, or about 0.25 wt % to about 1.0 wt %, or about 0.8 wt % of dry weight of the glass fibers, provided that the graphite particles are about 1 to 50 microns in size.

Although the graphite alone can confer static free characteristics of the fiberglass material, adding other substances to the fiberglass material may be beneficial. For example, a de-dusting oil such as Synthospin P10 (Lenox Chemical Company) or a suitable process oil may be used to treat the glass fibers to reduce dust formation during processing, packaging or installation of the fiberglass material. Optionally, a lubricant, silicone or a binder may also be included.

A specific insulation material substantially free of static electricity contains loose-fill fiberglass and graphite powder distributed on the surface thereof to facilitate anti-static property. The graphite treated loose-fill fiberglass may be bonded or non-bonded. Bonded loose-fill insulation refers to loose-fill fiberglass which has been treated with a thermoset binder to form a blanket or a batt, pulverized, compressed, and bagged. Non-bonded, loose-fill insulation comprises smaller short fibers, compressed and packaged into bags. A typical bag contains about 25-35 lbs of the insulation material. Both bonded and non-bonded loose fill insulations can be installed in attics and sidewalls using a pneumatic blowing machine or a similar equipment. The graphite coated loose-fill fiberglass insulation can be easily installed within the desired area. The insulation material can be blown to a distant location and does not accumulate dust. The material does not generate significant static electricity that may cause an electrical shock to the installer or may cause clogging up of the blowing machine.

A method for producing the fiberglass material substantially free of static electricity involves mixing graphite with glass fibers so that the graphite is evenly distributed on the glass fibers. As previously mentioned, the graphite used in the process may be a natural material or synthetic material. It may be pure or substantially pure having the carbon content of about 80 wt % to about 100 wt %. Although a purity of more than about 98% is more desirable. The graphite may be used in the forms of dry powder, flakes, or suspension. The examples of commercial graphite that have been used in the dry application are A99 graphite (Asbury Graphite Mills Inc.), which is synthetic powdered graphite, and 230U graphite (Asbury Graphite Mills Inc.), which is a natural flake type. Both types of graphite have particle sizes of about −325 mesh (the mean size of 25 microns, and the maximum size of 44 microns).

For a dry application, initial tests were performed using synthetic graphite powder with an average particle size of 3.3 microns and natural graphite flakes having an average size of 188 microns. About 10 grams of the synthetic graphite or 50 grams of the natural graphite was mixed with a bag of loose-fill fiberglass material (28-34 pounds) as it was being fed into a blowing machine for installation. It was observed that there was a significant reduction in the static electricity generated. There was little to no difficulty in the installation of the fiberglass material that is caused by static electricity.

In another dry application experiment, the dry graphite powder was “salted” on the loose-fill fiberglass at the rates of about 30 and 60 grams per bag of fiberglass (28-34 pounds) (LOI, Loss of Ignition, value of about 0.22% and 0.44%, respectively). In addition, a de-dusting oil or Synthospin P10, was optionally added at the rate of 0.25% LOI. The graphite used in this experiment was a synthetic, powdered graphite at 98% carbon content, having the particle size of about −325 mesh (44 microns). This graphite did not contain silica. Several bags of graphite treated loose-fill fiberglass were prepared and tested against the baseline material (no graphite). The resulting graphite-treated fiberglass products showed a significant reduction in static electricity during installation of the loose-fill fiberglass insulation. It was observed however that if the air condition is dry during the production of the fiberglass material, the absence of liquid antistatic may slow down the glass fibers running through the bagging operation. This was due to the amount of static produced by the process which caused the glass to hang up in the weight hopper, thus producing light bags and eventually shutting the line down.

The graphite powder or flakes may be first prepared as a dispersion in oil or water before applying to the glass fibers. Alternatively, commercial graphite suspension may also be used. For example, Graphokote 784 (Dixon graphite) a graphite impregnated in process oil), has been tried. Independent from the type of graphite used, the graphite content in the dispersion may be adjusted to a suitable level. To facilitate the dispersion of the graphite in the fluid, a dispersant such as TAMOL SN (Rohm & Haas Company) or a wetting agent may be added. For example, a dispersion may be made using A99 or 230U in water, yielding graphite content of about 3.4 wt %. The dispersion may be applied to the glass fibers at a graphite rate of about 0.25 wt % to about 0.50 wt %, or about 0.25 wt % to about 1.0 wt %, or about 0.8 wt % of dry weight of the glass fibers. A thickener may also be added to increase the viscosity of the dispersion. The dry and wet ingredients may be mixed in a container or a bag with sufficient agitation to prevent the graphite particles from settling at the bottom of the container before use. Small amounts of de-dusting-oil and silicone may be added to the dispersion at a rate of 0.1 wt % to 2.0 wt % to improve the processing and installation quality of the insulation material. If desired, a dye may also be added. Alternatively, the de-dusting oil and silicone may be applied to the glass fibers separately from the graphite dispersion.

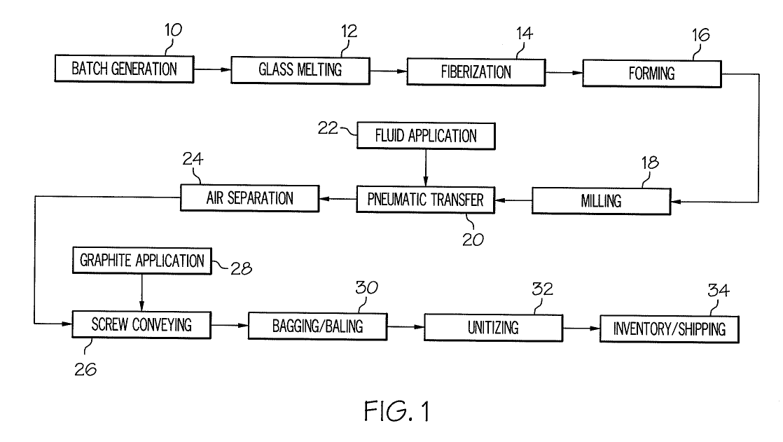

The method of producing substantially static free fiberglass insulation material is applicable to the manufacturing process of the loose-fill fiberglass insulation. Referring now to FIG. 1, a diagram demonstrating a manufacturing process of a loose-fill fiberglass insulation material is shown. The manufacturing process begins with a batch generation 10 in which ingredients for the batch are collected and transferred to a glass melting process 12. The melting process 12 consists of mixing and melting the multiple, solid ingredients of the batch. The molten glass is then transferred via a network of canals and forehearths towards the fiberization process 14.

The fiberization process 14 mainly consists of spinning the molten glass, via rotary process, into glass fibers. This is done at a controlled mass rate. The fiberization process is designed such that a targeted fiber diameter and length is produced. Typically, this is accomplished by multiple spinning machines, also known as fiberizers. The newly formed, virgin glass fibers are then directed toward the forming process 16 in which the fibers are captured inside a tower, on a forming chain. The forming chain or forming conveyor then transfers a blanket of the fibers towards the milling process 18.

The blanket of virgin fibers exiting the forming process 16 enters a chopping mill of the milling process 18. The purpose of the milling process 18 is to separate the blanket into smaller clumps as well as to consistently cut the virgin fibers to a controlled length. Upon exiting the milling process 18, the fibers are pneumatically transferred 20 to a separate part of the plant. During the pneumatic transfer 20, multiple fluids are applied to the glass. This fluid application process 22 is done by air atomizing and spraying each fluid into the air stream of the pneumatic transfer process 20. Each fluid then coats the glass fibers. The fluids may protect the glass fibers from moisture, may knock down smaller, dustier fibers, and may control static electricity. The multiple fluids are typically applied at 1.0-1.5% solids by weight of glass.

To further process the glass fibers, textile separators may separate the glass fibers from the pneumatic transfer process using air separation 24. The air separation process 24 may result in the separated fibers having a blanket form.

The newly formed glass fiber blanket, upon exiting the air separation process 24 is conveyed via a large diameter screw during a screw conveying process 26. The purpose of the screw conveying process 26 is two-fold. First, the screw conveying process 26 is responsible for breaking the blanket formed by the air separation process 24 into small pieces, without harming the glass fibers. Second, the screw conveying process 26 aids the graphite application process 28. The graphite application process 28 applies a dry, powdered graphite to the glass fibers during the screw conveying process 26. The graphite helps eliminate generation of static electricity during the installation of the glass fibers such as blowing such fibers into an attic for insulation. The graphite used is synthetic (>99.5% carbon), milled to a particle size of −325 mesh. This powdered graphite is metered onto the glass, during the screw conveying process 28, via a volumetric screw feeder. The speed of the volumetric screw feeder is controlled to coincide with the mass of the glass. In one embodiment, the graphite is applied at 0.5% by weight of glass. Research has shown that higher levels of graphite on the glass are more favorable in eliminating the generation of static electricity during the final installation process. Thus, another embodiment applies the graphite at 0.8% by weight of glass.

Upon exiting the screw conveying process 26 and graphite application process 28, the glass undergoes a bagging and baling process 30. During the bagging and baling process 30, the glass fibers enter machines that compresses 30-32 lbs of glass into a bale and inserts the compressed glass bale into a bag. Each bale then undergoes a material handling process 32 in which the bales are neatly stacked into piles or units for storage and shipping. As shown at 34, the units are now ready to be inventoried in a warehouse before being shipped to the customer.

### EXAMPLE 1

### Water Dispersion Applied at Fiberization Process 14

This experiment involved injecting an atomized water and graphite dispersion prepared as above-described into the virgin glass fiber veil immediately after the fiberization process 14. Both synthetic and natural graphite were tested, each at two different graphite levels, 0.25% LOI and 0.50% LOI. As expected, the heat of the fiberization process 14 vaporized the water carrier quickly, leaving behind the graphite powder on the glass.

The dispersion was prepared in water with approximately 3.4 wt % graphite. A very small amounts of dispersant was added to help in wetting the graphite in the water. In addition, a small amount of thickener was added to increase the viscosity of the mix and thus slowing the fall out rate. This mix enabled the application of graphite at a rate of 0.5 wt % of dry weight of glass. The dispersion was mixed by hand in clean, empty totes. The dispersion was transferred from a tote to the fiberizer deck by pumping through a 1-inch hose. A half inch hose was branched off of the 1-inch hose supply line near the MicroMotion that carried excess dispersion back down to the tote. The recirculation of the dispersion helped in agitation and keeping the dispersion in suspension.

### EXAMPLE 2

### Dry Powder Applied into Duct Air Stream After the Milling Process 18

This process involved injecting a dry, powdered graphite (synthetic, −325 mesh, 99.7% carbon) into a transport duct of the pneumatic transfer process 20 at approximately 10 feet after a Munson Mill of the milling process 18. The graphite flow rate of 0.25 wt % of dry weight of glass was applied. This process employed the transport duct, that was used to pneumatically convey the glass during the transfer process 20, to convey the powdered graphite with it, thereby packaging both the graphite and the glass in a bag at the end of the process.

### EXAMPLE 3

### Process Oil Dispersion Applied at Fluid Application 22 During Pneumatic Transfer 20

At this location, a graphite impregnated oil prepared from Graphokote 784 which contains 75% Paralux process oil and 25% synthetic graphite by weight, in suspension was used. The Graphokote at two different levels (0.50 and 1.00% LOI) was used. Since the Graphokote is actually 25% graphite by weight, this should only yield actual graphite LOI's of 0.13 and 0.25%. The graphite dispersion was pumped at a controlled flow and atomized as it was injected into the air stream of the duct, thereby allowing them to attach to the glass fibers.

### EXAMPLE 4

### Dry Powder Applied into Air Duct of Pneumatic Transfer Process 20 Before Air/Fiber Separation Process 24

At this location, dry powdered synthetic graphite (−325 mesh, 99.7% carbon) was applied into the air stream at both 0.25 wt % and 0.50 wt % of dry weight of the glass. This was similar to the process described in Example 2. The air/fiber separator drum, as it separated the glass fibers and air stream, created a continuous sheet of glass fibers on the outside of the drum. Applying dry powder here employed this continuous sheet to filter the dry powder from the air stream, thus keeping the powder on the glass fibers.

### EXAMPLE 5

### Dry Powder Applied to Glass Fibers on Conveyer During Screw Conveying Process 26

At this location, dry powdered, synthetic graphite (−325 mesh, 99.7% carbon) was “salted” at both 0.25 wt % and 0.50 wt % of dry weight of the glass on the continuous sheet of glass fibers created by the air/fiber separator drum, immediately before the glass fibers are bagged for shipping. The dry powder was carried along with the glass fibers through the bagging operation where it ended up with the glass fibers in the finished, packaged product.

In addition, samples with a very high level of graphite LOI (4%) was also produced by sprinkling the graphite powder on to the forming chain (sheet) of the glass fiber.

Several bags of fiberglass material were produced in accordance with the above examples (see Table). It is notable that in conjunction with the two different levels of graphite for each set point, the materials were made with and without Synthospin P10, always keeping the overall fluids LOI at 1.25%. It was required that the de-dusting oil and silicone were to be added in accordance with sans P10 set points. In addition, a dye was added to all set points containing Synthospin P10 to observe the effect of graphite to the color of certain fiberglass products.

TABLE
Examples of fiberglass materials prepared by applying graphite
to glass fibers at different locations of a manufacturing process

| | GRAPHITE | | |
|---|---|---|---|
| ADDITIVE CHANGES | LOI | APPLICATION LOCATION | # BAGS |
| NONE-BASELINE MTL | 0.00% | N/A | 28 |
| WATER + A99 DISPERSION | 0.25% | FIBERIZER RINGS OF | 28 |
| | | FIBERIZATION | |
| WATER + A99 DISPERSION | 0.50% | FIBERIZER RINGS OF | 28 |
| | | FIBERIZATION | |
| WATER + A99 DISPERSION, NO SYNTHOSPIN P10 | 0.25% | FIBERIZER RINGS OF | 28 |
| | | FIBERIZATION | |
| WATER + A99 DISPERSION, NO SYNTHOSPIN P10 | 0.50% | FIBERIZER RINGS OF | 28 |
| | | FIBERIZATION | |
| GRAPHOKOTE 784, NO DDO | 0.13% | INJECTION AREA OF FLUID | 28 |
| | | APPLICATION | |
| GRAPHOKOTE 784, NO DDO | 0.25% | INJECTION AREA OF FLUID | 28 |
| | | APPLICATION | |
| GRAPHOKOTE 784, NO DDO, NO SYNTHOSPIN P10 | 0.25% | INJECTION AREA OF FLUID | 28 |
| | | APPLICATION | |
| GRAPHOKOTE 784, NO DDO, NO SYNTHOSPIN P10 | 0.50% | INJECTION AREA OF FLUID | 28 |
| | | APPLICATION | |
| NONE-BASELINE MTL | 0.00% | N/A | 28 |
| NONE-BASELINE MTL | 0.00% | N/A | 28 |
| A99 DRY POWDER | 0.25% | TRANS. DUCT POST MILL | 28 |
| A99 DRY POWDER | 0.50% | TRANS. DUCT POST MILL | 28 |
| A99 DRY POWDER, NO SYNTHOSPIN P10 | 0.25% | TRANS. DUCT POST MILL | 28 |
| A99 DRY POWDER, NO SYNTHOSPIN P10 | 0.50% | TRANS. DUCT POST MILL | 28 |
| A99 DRY POWDER | 0.25% | TRANS. DUCT PRE AIR/FIBER | 28 |
| | | SEPARATOR. | |
| A99 DRY POWDER | 0.50% | TRANS. DUCT PRE AIR/FIBER | 28 |
| | | SEPARATOR.. | |
| A99 DRY POWDER, NO SYNTHOSPIN P10 | 0.25% | TRANS. DUCT PRE AIR/FIBER | 28 |
| | | SEPARATOR.. | |
| A99 DRY POWDER, NO SYNTHOSPIN P10 | 0.50% | TRANS. DUCT PRE AIR/FIBER | 28 |
| | | SEPARATOR.. | |
| A99 DRY POWDER | 4.00% | FORMING CHAIN OF FORMING | 28 |
| | | PROCESS | |
| A99 DRY POWDER, NO SYNTHOSPIN P10 | 4.00% | FORMING CHAIN OF FORMING | 28 |
| | | PROCESS | |
| NONE-BASELINE MTL | 0.00% | N/A | 28 |

The results of the above examples show that the method of producing graphite treated fiberglass material can be integrated into the manufacturing process of the loose-fill fiberglass insulation. Further, there was good evidence that indicated that the process in Example 1 appeared to be favorable. This is where a water and graphite dispersion was atomized and injected into the virgin glass fiber veil, immediately after the fiberization process. There was good evidence on the glass that indicated adhesion of the graphite particles on the fiberglass. This was evident by the color of the glass that changed from bright white to very light grey. Another favorable feature for this application was the cleanliness involved, when compared to injecting dry powder. The dry powder, because of its fineness, was prone to become airborne. For water and graphite dispersion, however, the graphite was wet and thus not prone to become airborne. Further, the end of line testing in the plant, for this process, proved to be successful in terms of static electricity suppression, when compared to a baseline product. The baseline product (no graphite) showed strong evidence that it was able to generate static electricity with the installation hose while it was being installed. This static electricity produced was highly unfavorable.

In a field evaluation in which the fiberglass end products were evaluated by installers, the products produced in accordance with Example 5 (salting the conveyed product with dry power), both the 0.25 wt % and 0.50 wt % graphite treated materials, were tested with a baseline product (no graphite). It was observed that the baseline product generated significant static electricity. However, the products containing graphite proved to produce significantly less static. It was also deemed much more favorable by the installers. This trial also showed that the fiberglass insulation having graphite at 0.50 wt % performed better than that having graphite at 0.25 wt % regarding static reduction.

In another field evaluation, the products produced in accordance with Example 1 (water and graphite dispersion applied at the fiberizer) were tested. The products included the products produced with either the synthetic or the natural flake type of graphite, coupled with the two levels (0.25 wt % and 0.50 wt % by dry weight of glass) applied. Again, the baseline product proved to be high in static and very unfavorable to the installer. However, all of the products containing graphite showed significant reduction in static, the best being the synthetic graphite applied at 0.50 wt % by dry weight of the glass.

While the invention has been illustrated and described in detail in the drawings and foregoing description, the same is to be considered as illustrative and not restrictive in character. It should be understood that only the exemplary embodiments have been shown and described and that all changes and modifications that come within the spirit of the invention are desired to be protected.

What is claimed is:

1. A fiberglass material, comprising:
glass fibers; and
graphite, substantially free of silica, disposed on the glass fibers to substantially prevent build up of static electricity on the glass fibers.

2. The fiberglass material of claim 1, wherein the graphite comprises about 0.25 wt % to about 0.5 wt % of dry weight of the glass fibers.

3. The fiberglass material of claim 1, wherein the graphite comprises about 0.25 wt % to about 1.0 wt % of dry weight of the glass fibers.

4. The fiberglass material of claim 1, wherein the graphite comprises about 0.8 wt % of dry weight of the glass fibers.

5. The fiberglass material of claim 1 further comprising a de-dusting material disposed on the glass fibers.

6. The fiberglass material of claim 1, further comprising silicone disposed on the glass fibers.

7. The fiberglass material of claim 1, wherein particle sizes of the graphite range from about 1 micron to about 50 microns.

8. The fiberglass material of claim 1, wherein the glass fibers comprise loose-fill fiberglass.

9. An insulating product made from the fiberglass material of claim 1.

10. A method for producing a fiberglass material substantially free of static electricity comprising adding graphite, substantially free of silica, to glass fibers such that the graphite is distributed and attached to the glass fibers.

11. The method of claim 10, wherein the graphite comprises a powder having particle sizes of about 1 micron to about 50 microns.

12. The method of claim 10, wherein the graphite comprises flakes of about 1 micron to about 50 microns.

13. The method of claim 10, wherein the graphite consist essentially of a synthetic material having carbon content of about 99% or more.

14. The method of claim 10, wherein the graphite contains no silica.

15. The method of claim 10, wherein adding the graphite comprises adding the graphite at a rate of about 0.25 wt % to about 0.5 wt % of dry weight of the glass fibers.

16. The method of claim 10, wherein adding the graphite comprises adding the graphite at a rate of about 0.25 wt % to about 1.0 wt % of dry weight of the glass fibers.

17. The method of claim 10, wherein adding the graphite comprises adding the graphite at a rate of about 0.8 wt % of dry weight of the glass fibers.

18. The method of claim 10 further comprising applying a de-dusting oil on the glass fibers.

19. The method of claim 10 further comprising
mixing the graphite with a fluid to form a dispersion before adding graphite to the glass fibers;
applying the dispersion to the glass fibers; and
drying the glass fibers so that the graphite is left attached to the glass fibers.

20. The method of claim 19, wherein the fluid is water or oil.

21. The method of claim 19 further comprising applying a de-dusting oil to the glass fibers.

22. The method of claim 21, wherein a de-dusting oil is mixed in with the dispersion before applying the dispersion to the glass fibers.

23. The method of claim 22, wherein the de-dusting oil is applied to the glass fibers at a rate of about 0.1 wt % to about 2.0 wt % of dry weight of the glass fibers.

24. The method of claim 19, wherein a dispersant, a thickener, a wetting agent, or a combination thereof is added to the dispersion.
